(19) United States
(12) Patent Application Publication
(10) Pub. No.: US 2020/0219035 A1
(43) Pub. Date: Jul. 9, 2020

(54) AUTOMATED DIGITAL BADGE MANAGMENT

(71) Applicant: INTERNATIONAL BUSINESS MACHINES CORPORATION, ARMONK, NY (US)

(72) Inventors: Sushain Pandit, Austin, TX (US); Su Liu, Austin, TX (US); Fang Wang, Westford, MA (US); Martin Oberhofer, Sindelfingen (DE)

(21) Appl. No.: 16/239,724

(22) Filed: Jan. 4, 2019

(51) Int. Cl. G06Q 10/06; H04L 29/08

(52) U.S. Cl. CPC G06Q 10/06398; H04L 67/306

(57) ABSTRACT

An automated digital badge management system and method for automating and providing digital badge recommendations is provided. The method may include receiving role data in response to a selection at an automated digital badge management graphical user interface and proficiency data collected in part from an automated digital badge management client device. The method may further include creating an instantiation of an automated digital badge management system data structure. The method may also include populating the automated digital badge management system data structure with the role data and the proficiency data. The method may additionally include determining a recommended digital badge to achieve and one or more recommended actions to perform to achieve the recommended digital badge based on the role data and the proficiency data in the automated digital badge management system data structure. Moreover, the method may include providing the recommended digital badge to achieve.

### BACKGROUND

The present disclosure relates to systems and methods for automated digital badge management, and more specifically to embodiments of an automated digital badge management system and methods for recommendation of digital badges to achieve.

Digital badges may be validated indicators of accomplishment, skill, quality or interest that can be earned in various learning and working environments. Digital badges may be certifiable and transferable, be associated with one or more images, and may include information or data about skills, experience, achievements, an actual digital badge holder or recipient, and an organization controlling or providing the digital badge. This information may be embedded in the digital badge itself (e.g., a file) and may be shown electronically (e.g., on the internet or over professional or social applications).

Organizations may issue digital badges under a standard or specification. The digital badges may represent achievements and skills such as management or collaboration skills, computer programming or engineering design skills, certifications, etc. Holders of digital badges may display or publish their digital badges (which may be received from multiple organizations such as corporations, institutions, universities, employers, etc.) electronically to show their achievements and skills in, for example, in a certain job role, title, or domain. Digital badges may be based on an open standard and recipients may display multiple badges from different digital badge providers.

### SUMMARY

Embodiments of the present disclosure relate to a method, and associated computer system and computer program product, for automating and providing digital badge recommendations. The method may include receiving role data in response to a selection at an automated digital badge management graphical user interface and proficiency data collected in part from an automated digital badge management client device. The method may further include creating an instantiation of an automated digital badge management system data structure. The method may also include populating the automated digital badge management system data structure with the role data and the proficiency data. The method may additionally include determining a recommended digital badge to achieve and one or more recommended actions to perform to achieve the recommended digital badge based on the role data and the proficiency data in the automated digital badge management system data structure. Moreover, the method may include providing the recommended digital badge to achieve and the one or more recommended actions to perform to achieve the digital badge to the automated digital badge management client device.

In an implementation, the method may include displaying the recommended digital badge to achieve and the one or more recommended actions to perform to achieve the recommended digital badge at the automated digital badge management client device. The method may further include receiving further proficiency data associated with the one or more recommended actions to perform to achieve the recommended digital badge. The method may also include updating the one or more recommended actions to perform based on the further proficiency data. The method may additionally include providing the updated one or more recommended actions to perform to the automated digital badge management client device. Moreover, the method may include updating the automated digital badge management system data structure to indicate that the recommended digital badge has been achieved.

One or more of the following features may be included. The automated digital badge management system data structure indicates digital badges achieved and further recommended digital badges to achieve based on the role data and the proficiency data in the automated digital badge management system data structure. The method may include evaluating the role data and the proficiency data in the automated digital badge management system data structure to determine progress towards one or more digital badges not yet achieved. The method may further include monitoring actions performed by a user related to one or more digital badges. The method may also include updating the proficiency data in the automated digital badge management system data structure based on the actions performed.

### BRIEF DESCRIPTION OF THE DRAWINGS

FIG. 1 depicts a block diagram of an automated digital badge management system, in accordance with embodiments of the present disclosure.

FIG. 2 depicts a flow chart of a method for automating and providing digital badge recommendations, in accordance with embodiments of the present disclosure.

FIG. 3 depicts a diagrammatic flow chart illustrating a client-server system in accordance with embodiments of the present disclosure.

FIG. 4A depicts an example automated digital badge management data structure in accordance with embodiments of the present disclosure.

FIG. 4B depicts normalized digital badge criteria in accordance with embodiments of the present disclosure.

FIG. 5 illustrates a block diagram of a computer system for the automated digital badge management system of FIG. 1, capable of implementing the methods for automating and providing digital badge recommendations of FIG. 2, in accordance with embodiments of the present disclosure.

FIG. 6 depicts a cloud computing environment, in accordance with embodiments of the present disclosure.

FIG. 7 depicts abstraction model layers, in accordance with embodiments of the present disclosure.

### DETAILED DESCRIPTION

Digital gamification techniques (e.g., electronically giving out instant credits/awards/incentives) may be implemented as incentives to employees or other members of an organization. This may enhance productivity and/or efficiency of employees and/or introduce an element of fun or friendly competition in a work environment.

One of these gamification techniques may include control, provision, and/or issuance of digital badges introduced as validated indicators of accomplishment, skill, quality or interest that may be earned in various learning and working environments. Digital badge systems may include enhancements to make it easier to find the right digital badge and/or to keep track of digital badges. For example, digital badge guides may guide users to find new courses and/or learn new skills. Various systems may track a learning status of users seeking digital badges.

However, the universe of digital badges may be difficult to navigate. Digital badges exist in the digital universe, on the internet, or otherwise electronically, and may pose difficult technical problems which require technical solutions inherent to computer and internet technology. For example, users may find it difficult to understand which digital badges to pursue, which digital badges make sense for them to consider, and which digital badges they may easily obtain in light of their current level of achievement and experience. Additionally, digital badge application processes may be complicated and confusing. Individuals may have no idea when, where, and how to apply and receive digital badges, and may ask the following questions: What kind of badges are recommended based on my current skills, experience, role and personal career path? According to my current skills and experience, is there a dynamic list of digital badges for which I can apply? What is the next digital badge for me to logically pursue? What kinds of skills and experiences are required for getting my next digital badge? How many courses or digital badges do I need for receiving a new digital badge based on my profile, skills, and experience?

Assistance and guidance for users to plan their digital badge paths and manage their skills may be hard to come by. Available roadmaps for digital badges may be manually static, not customizable, and overall not very helpful. Even when users have determined which digital badges to pursue, there may be few ways for users to show their current skills and experience without manually entering or showing it. Hours of experience, either learning, sharing, teaching, or developing in a certain digital badge subject area may be difficult to track, show, and/or prove.

Thus, there may be a gap between the current digital badge offerings abundantly available and the management of, recommendations for, and tracking of progress and issuance of digital badges. There may be a need to help users to gain insight on their personal skills and experiences in order to pursue digital badges and manage the digital badge process.

Using the techniques and features described in the present disclosure, digital badge management and recommendation may be automated and digital badge recommendations may be provided. An automated digital badge management system and associated methods as described in the present disclosure may help users dynamically assess their skills, easily learn of new digital badges to pursue, manage currently held digital badges, expose users to possible career paths, and overall improve the ease and quality of training and career advancement.

An automated digital badge management framework may be based on a personal skill assessment analysis for helping a user manage possible digital badges, career paths, skills growth plans, and a self-training schedule. An automated digital badge management data structure may be used to store, organize, and access various data associated with a user and available, recommended, or desired digital badges. An associated method or process may include evaluating a user's career path, digital badge plan, and/or steps for obtaining targeted or recommended digital badges. The method may further include tracking user career and job related factors, activities, and events. The method may also include recommending available digital badges for the user to work towards. The method may additionally include allowing the user to select and set at least one role or goal.

The automated digital badge management method may then collect the knowledge or skills indications, digital badge points, new skills from the tracked activities and events, etc., for the user. The method may also identify a new gained skill and a step for targeting a new digital badge. A personal growth roadmap may be generated and updated. Remaining steps and points which need to be achieved to obtain the target digital badge may be displayed. A goal set may be determined based in certain constraints, the user's skill, role, career path, etc. Based on the user's selected goals, the automated digital badge management method may generate a recommendation based on the constraints. The automated digital badge management system may learn from a recommendation history to optimize new recommendations to the users.

In an embodiment, an automated digital badge management system and method or process for automating and providing digital badge recommendations may include receiving role data in response to a selection at an automated digital badge management graphical user interface and proficiency data collected in part from an automated digital badge management client device. The method may further include creating an instantiation of an automated digital badge management system data structure. The method may also include populating the automated digital badge management system data structure with the role data and the proficiency data. The method may additionally include determining a recommended digital badge to achieve and one or more recommended actions to perform to achieve the recommended digital badge based on the role data and the proficiency data in the automated digital badge management system data structure. Moreover, the method may include providing the recommended digital badge to achieve and the one or more recommended actions to perform to achieve the digital badge to the automated digital badge management client device.

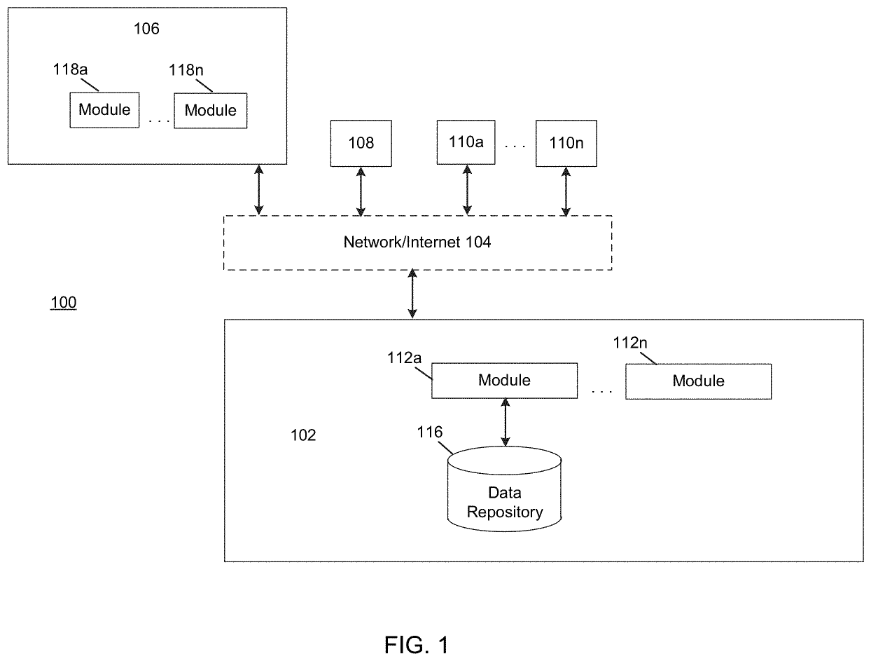

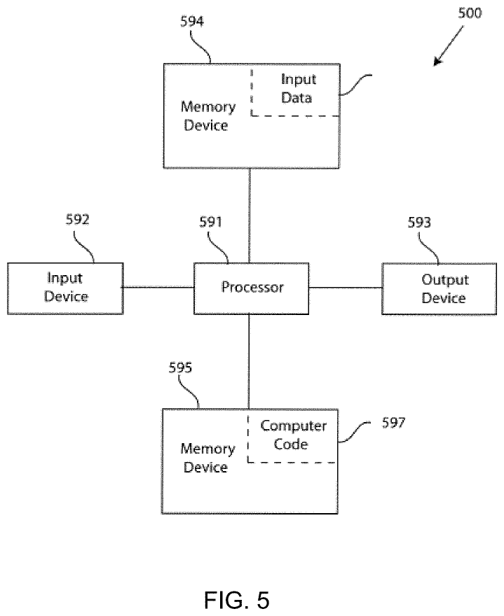

Referring to the drawings, FIG. 1 depicts a block diagram of an automated digital badge management system 102 in a digital badge environment 100, in accordance with embodiments of the present disclosure. Embodiments of the automated digital badge management system 102 may determine a recommended digital badge to achieve in the digital badge environment 100. The various computer systems shown in FIG. 1, including automated digital badge management system 102, may be similar to and/or include similar components to the computer system of FIG. 5. In embodiments, automated digital badge management system 102 may be or may run on an automated digital badge management server as described herein.

Automated digital badge management system 102 may be in communication with a network 104 and/or the Internet through which automated digital badge management system 102 may communicate with various other computer systems and machines. For example, automated digital badge management system 102 may communicate with automated digital badge management system client devices 106, 108, and various user computer systems 110a . . . 110n which may also be automated digital badge management system client devices.

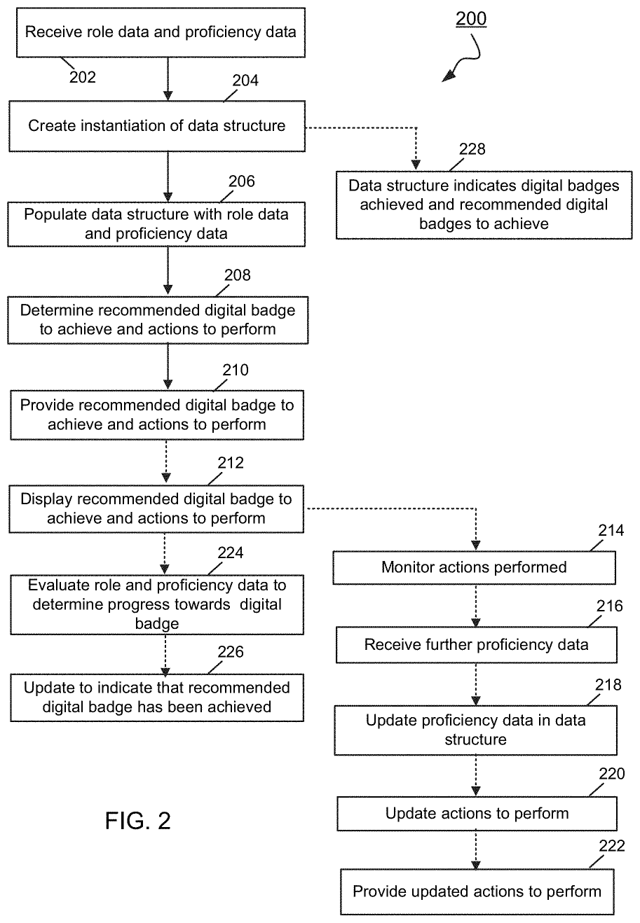

Automated digital badge management system 102 may include one or more modules 112a-112n, in accordance with embodiments of the present disclosure. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 102. A module (whether hardware, software, or a combination thereof) may be designed to implement or execute one or more particular functions, routines, or operations, such as those shown in the blocks of FIG. 2. Similarly, automated digital badge management system client device 106 may include modules 118a-118n.

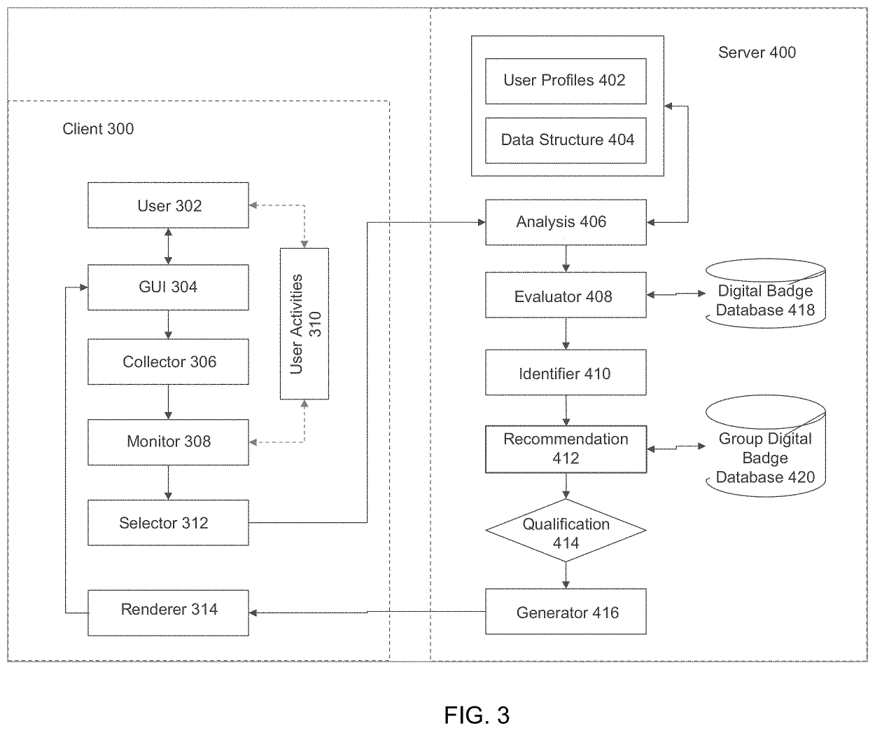

In an example automated digital badge management system client device 106 may include automated digital badge management client 300 as shown in FIG. 3. Additionally, embodiments of the modules 118a-118n may include one or more components of hardware and/or software program code for implementing or executing one or more particular functions, routines, or operations, such as those shown in blocks 302-314 in FIG. 3 and described below. Further, an example of an automated digital badge management system 102 may include automated digital badge management server 400 as shown in FIG. 3 Similarly, embodiments of the modules 112a-112n may include one or more components of hardware and/or software program code for implementing or executing one or more particular functions, routines, or operations, such as those shown in blocks 402-416 in FIG. 3 and described below.

Automated digital badge management client 300 may be a personal automated digital badge management application and may be installed in a client device (e.g., client device 106) which may be in communication with automated digital badge management server 400 (e.g., via the internet). Automated digital badge management client 300 may configure a user via a user module 302.

Further, automated digital badge management client 300 may render an automated digital badge management graphical user interface (GUI) via GUI module 304. The graphical user interface may be displayed to a user at a client device and may be used for configuring and customizing automated digital badge management service. For example, the user may set a user role or user goal and track, input, or designate sources for inputting professional skills, experience and education status into the automated digital badge management system. The settings entered in the graphical user interface or retrieved by the automated digital badge management system via the designated sources (e.g., online professional or social media applications or local resumes) may be collected and saved into a user profile with a user information collector module 306.

For instance, a user may set a role as “Architect of Cognitive System” through the graphical user interface and the automated digital badge management system may track any “Architect of Cognitive System” related activities, experience, or education, and suggest that the user apply for a corresponding digital badge when the user's experience and skills meet the “Architect of Cognitive System” digital badge criteria.

Automated digital badge management client 300 may also include an automated digital badge management monitor module 308 which may be a module for tracking a user's personal, career, and job related factors, activities, and events. For instance, and continuing with the example above, if the user takes or attends any “Architect of Cognitive System” related courses or conferences or performs any related production or development work, the monitor module may track those user activities and store them in the user profile, as shown in block 310. Collector module 306 may collect and extract important learned knowledge, digital badge points, and/or new skills from the tracked activities and events.

Automated digital badge management client 300 may also include an automated digital badge management selector module 312. The selector module 312 may allow a user to view and select currently available digital badges and/or digital badges possible for the user to obtain (e.g., a TCP/IP Specialist digital badge, Senior Project Manager digital badge, Security Architect digital badge, etc.).

Automated digital badge management client 300 may also include an automated digital badge management road map rendering module 314. The rendering module 314 may display returned badge information, such as remaining steps and points which need to be archived for target digital badges associated with the user.

Further, Automated digital badge management server 400 may be an example of system 102 and may be in communication with automated digital badge management client 300 (e.g., via the internet). Automated digital badge management server 400 may be configured with a skill analysis engine or module 406 for processing input from the automated digital badge management client 300 and determining if a user is qualified for a digital badge. The skill analysis engine or module 406 may be a SaaS API for supporting automated digital badge management.

Automated digital badge management server 400 may include an automated digital badge management data structure module 404 which may manage a data structure and instances of the data structure for storing a skill development status in different knowledge areas, role data, proficiency data, and other user related data as discussed herein. The data structure may include fields for user ID, job descriptor, title ID, SME (Subject Matter Experts) field, professional membership list, published paper list, patent list, award list, job history, owned badge list, short term badge list, long term badge list, classes taken list, and suggested classes list, for example.

Automated digital badge management server 400 may also include an automated digital badge management evaluator module 408 which may acquire user data and user profile information, evaluate the user's career path, examine the user's digital badge plan, and measure the user's gap or distance to the next digital badge. Further, automated digital badge management server 400 may include an automated digital badge management new skill identifier module 410 which may identify a newly gained skill and related steps progressed towards a target digital badge. Automated digital badge management server 400 may further include an automated digital badge management recommendation module 412 which may be a recommendation daemon for recommending available digital badges for the user to apply for and work towards.

Automated digital badge management server 400 may additionally include digital badge database 418 which may be a digital badge repository for collecting and saving digital badges and related digital badge criteria and requirements. Moreover automated digital badge management server 400 may include a growing roadmap generator module 416 which may generate and update a personal growth roadmap.

Referring now to FIG. 2, a flow chart of a process 200 for automating and providing digital badge recommendations, in accordance with embodiments of the present disclosure, is shown. One embodiment of a process 200 or algorithm that may be implemented for automating and providing digital badge recommendations in accordance with the automated digital badge management system 102 for digital badge environment 100 described in FIG. 1 may use one or more computer systems as defined generically in FIG. 5, and more specifically by the embodiments of FIG. 1. Further, process 200 may run on or be executed by an automated digital badge management server which may be similar to automated digital badge management system 102 and may be part of or may use portions of modules 112a-112n of FIG. 1 and/or modules 402-416 of FIG. 3.

Embodiments of the process 200 for automating and providing digital badge recommendations may include operations or steps 202-226 (among other operations not shown) as shown in FIG. 2. In an embodiment, process 200 may receive 202 role data in response to a selection at an automated digital badge management graphical user interface and proficiency data collected in part from an automated digital badge management client device (e.g., client device 106 via client 300). The role data may include a user's role or job entered in the graphical user interface (which may be rendered via GUI module 304) or otherwise selected and may be current or aspirational. The proficiency data may include education, classes taken, experience, skills, conferences attended, papers written, collaboration information, etc.

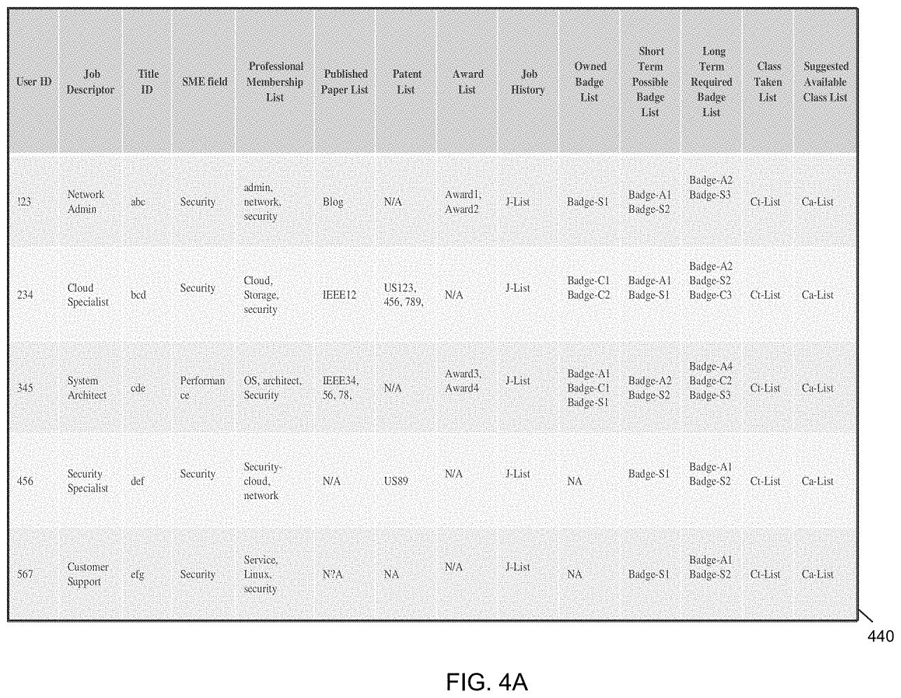

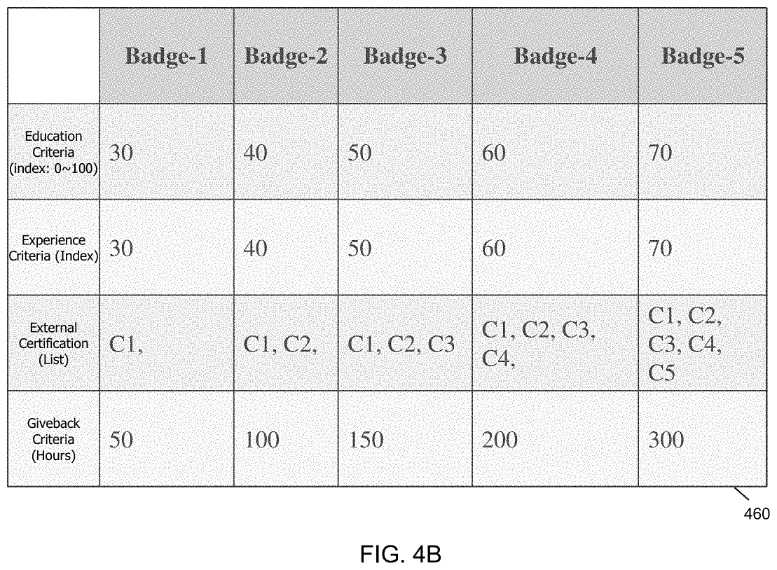

Further, process 200 may create 204 an instantiation of an automated digital badge management system data structure (e.g., via data structure module 404). An example of an instantiation 440 of the data structure is shown in FIG. 4A. Process 200 may further populate 206 the automated digital badge management system data structure with the role data and the proficiency data. As shown in FIG. 4A, the data structure fields may include user ID, job descriptor, title ID, SME field, professional membership list, published paper list, patent list, award list, job history, owned badge list, short term badge list, long term badge list, classes taken list, and suggested classes list, for example, and each field may be populated with data received.

Process 200 may also determine 208 a recommended digital badge to achieve and one or more recommended actions to perform to achieve the recommended digital badge. The recommended digital badge and recommended actions to perform may be based on the role data and the proficiency data in the automated digital badge management system data structure. Process 200 may additionally provide 210 the recommended digital badge to achieve and the one or more recommended actions to perform to achieve the digital badge to the automated digital badge management client device (e.g., client device 106 via client 300). Process 200 may display 212 the recommended digital badge to achieve and the one or more recommended actions to perform to achieve the recommended digital badge at the automated digital badge management client device (e.g., client device 106 via client 300).

In an implementation, the process 200 may monitor 214 (e.g., via monitor module 308) actions performed by a user related to one or more digital badges. Further, process 200 may receive 216 further proficiency data associated with the one or more recommended actions to perform to achieve the recommended digital badge. Process 200 may also update 218 the proficiency data in the automated digital badge management system data structure based on the actions performed. Process 200 may additionally update 220 the one or more recommended actions to perform based on the further proficiency data. Moreover, process 200 may provide 222 the updated one or more recommended actions to perform to the automated digital badge management client device (e.g., client device 106 via client 300).

In an implementation, process 200 may evaluate 224 (e.g., via evaluator module 408) the role data and the proficiency data in the automated digital badge management system data structure to determine progress towards one or more digital badges not yet achieved. Further, the process 200 may update 226 the automated digital badge management system data structure to indicate that the recommended digital badge has been achieved. The automated digital badge management system data structure may indicate 228 the digital badges achieved and further recommended digital badges to achieve based on the role data and the proficiency data in the automated digital badge management system data structure.

Referring now to FIG. 4B, an example of normalized digital badge criteria 460 is shown. Process 200 may normalize digital badge criteria based on index values and other factors and use the criteria to determine a digital badge level.

Using the techniques and features described in the present disclosure, a technical solution to the technical problem of confusion and lack of direction in achieving digital badges may be realized by providing an automated digital badge management system and related methods or processes.

FIG. 5 illustrates a block diagram of a computer system 500 that may be included in the system (e.g., as client device 102 or an automated digital badge management server 106) of FIG. 1 and for implementing the method or process of FIG. 2 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method or process for automating and providing digital badge recommendations, in the manner prescribed by FIG. 2 using the automated digital badge management system of FIG. 1, wherein the instructions of the computer code 597 may be executed by processor 591 via memory device 595. The computer code 597 may include software or program instructions that may implement one or more algorithms for implementing the method or process of automating and providing digital badge recommendations, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

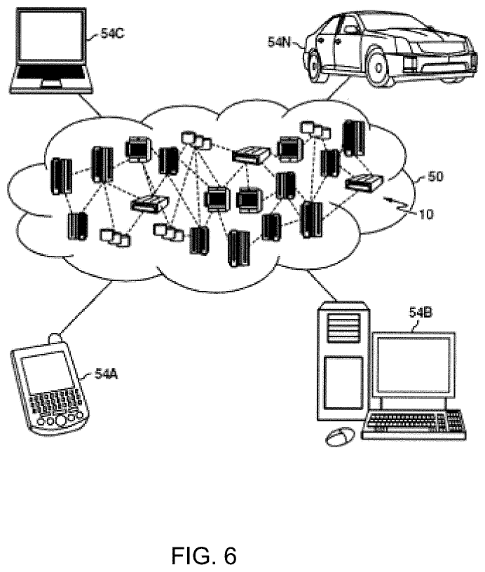

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 116 as shown in FIG. 1.

As will be appreciated by one skilled in the art, in a first embodiment, the present disclosure may describe a method; in a second embodiment, the present disclosure may describe a system; and in a third embodiment, the present disclosure may describe a computer program product. Any of the components of the embodiments of the present disclosure can be deployed, managed, serviced, etc. by a service provider that offers to deploy or integrate computing infrastructure with respect to an automated digital badge management systems and methods. Thus, an embodiment of the present disclosure is a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to automate and provide digital badge recommendations. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method or process for automating and providing digital badge recommendations. Thus, the present disclosure describes a process for supporting, deploying and/or integrating computer infrastructure, integrating, hosting, maintaining, and deploying computer-readable code into the computer system 500, wherein the code in combination with the computer system 500 is capable of performing a method or process for automating and providing digital badge recommendations.

A computer program product of the present disclosure comprises one or more computer readable hardware storage devices having computer readable program code stored therein, said program code containing instructions executable by one or more processors of a computer system to implement the methods or processes of the present disclosure.

A computer system of the present disclosure comprises one or more processors, one or more memories, and one or more computer readable hardware storage devices, said one or more hardware storage devices containing program code executable by the one or more processors via the one or more memories to implement the methods or processes of the present disclosure.

The present disclosure describes a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, 54C and 54N shown in FIG. 6 are intended to be illustrative only and that computing nodes 10 and cloud computing environment 50 can communicate with any type of computerized device over any type of network and/or network addressable connection (e.g., using a web browser).

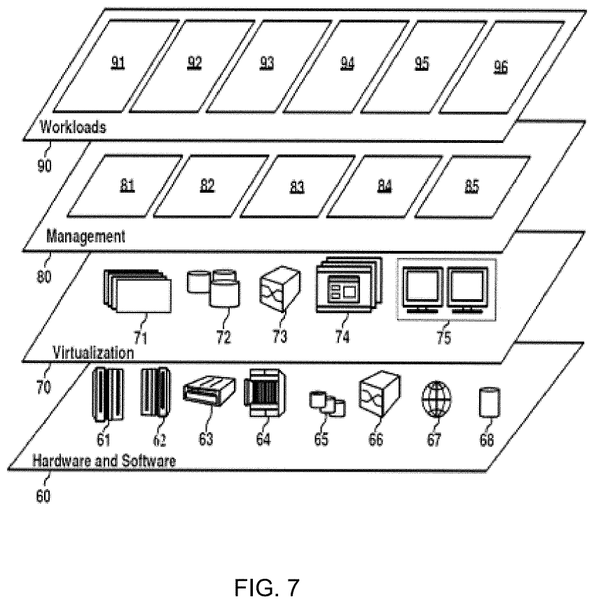

Referring now to FIG. 7, a set of functional abstraction layers provided by cloud computing environment 50 (see FIG. 6) is shown. It should be understood in advance that the components, layers, and functions shown in FIG. 7 are intended to be illustrative only and embodiments of the present disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and calendar management for determining availability of an invitee 96.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for automating and providing digital badge recommendations based on role data and proficiency data, the method comprising:
receiving, by an automated digital badge management system, role data in response to a selection at an automated digital badge management graphical user interface and proficiency data collected in part from an automated digital badge management client device;
creating, by the automated digital badge management system, an instantiation of an automated digital badge management system data structure;
populating, by the automated digital badge management system, the automated digital badge management system data structure with the role data and the proficiency data;
determining, by the automated digital badge management system, a recommended digital badge to achieve and one or more recommended actions to perform to achieve the recommended digital badge based on the role data and the proficiency data in the automated digital badge management system data structure; and
providing, by the automated digital badge management system, the recommended digital badge to achieve and the one or more recommended actions to perform to achieve the digital badge to the automated digital badge management client device.

2. The method of claim 1, further comprising:
displaying the recommended digital badge to achieve and the one or more recommended actions to perform to achieve the recommended digital badge at the automated digital badge management client device.

3. The method of claim 1, further comprising:
receiving further proficiency data associated with the one or more recommended actions to perform to achieve the recommended digital badge;
updating the one or more recommended actions to perform based on the further proficiency data; and
providing the updated one or more recommended actions to perform to the automated digital badge management client device.

4. The method of claim 1, further comprising:
updating the automated digital badge management system data structure to indicate that the recommended digital badge has been achieved.

5. The method of claim 1, wherein the automated digital badge management system data structure indicates digital badges achieved and further recommended digital badges to achieve based on the role data and the proficiency data in the automated digital badge management system data structure.

6. The method of claim 1, further comprising:
evaluating the role data and the proficiency data in the automated digital badge management system data structure to determine progress towards one or more digital badges not yet achieved.

7. The method of claim 1, further comprising:
monitoring, by the automated digital badge management system, actions performed by a user related to one or more digital badges; and
updating the proficiency data in the automated digital badge management system data structure based on the actions performed.

8. A computer system for automating and providing digital badge recommendations based on role data and proficiency data, comprising:
a processor;
a memory device coupled to the processor; and
a computer readable storage device coupled to the processor, wherein the storage device contains program code executable by the processor via the memory device to implement a method for automating and providing digital badge recommendations based on role data and proficiency data, the method comprising:
receiving, by the processor, role data in response to a selection at an automated digital badge management graphical user interface and proficiency data collected in part from an automated digital badge management client device;
creating, by the processor, an instantiation of an automated digital badge management system data structure;
populating, by the processor, the automated digital badge management system data structure with the role data and the proficiency data;
determining, by the processor, a recommended digital badge to achieve and one or more recommended actions to perform to achieve the recommended digital badge based on the role data and the proficiency data in the automated digital badge management system data structure; and
providing, by the processor, the recommended digital badge to achieve and the one or more recommended actions to perform to achieve the digital badge to the automated digital badge management client device.

9. The computer system of claim 8, further comprising:
displaying the recommended digital badge to achieve and the one or more recommended actions to perform to achieve the recommended digital badge at the automated digital badge management client device.

10. The computer system of claim 8, further comprising:
receiving further proficiency data associated with the one or more recommended actions to perform to achieve the recommended digital badge;
updating the one or more recommended actions to perform based on the further proficiency data; and
providing the updated one or more recommended actions to perform to the automated digital badge management client device.

11. The computer system of claim 8, further comprising:
updating the automated digital badge management system data structure to indicate that the recommended digital badge has been achieved.

12. The computer system of claim 8, wherein the automated digital badge management system data structure indicates digital badges achieved and further recommended digital badges to achieve based on the role data and the proficiency data in the automated digital badge management system data structure.

13. The computer system of claim 8, further comprising:
evaluating the role data and the proficiency data in the automated digital badge management system data structure to determine progress towards one or more digital badges not yet achieved.

14. The computer system of claim 8, further comprising:
monitoring, by the automated digital badge management system, actions performed by a user related to one or more digital badges; and
updating the proficiency data in the automated digital badge management system data structure based on the actions performed.

15. A computer program product, comprising a computer readable hardware storage device storing a computer readable program code, the computer readable program code comprising an algorithm that when executed by a computer processor of a computing system implements a method for automating and providing digital badge recommendations based on role data and proficiency data, comprising:
receiving, by the processor, role data in response to a selection at an automated digital badge management graphical user interface and proficiency data collected in part from an automated digital badge management client device;
creating, by the processor, an instantiation of an automated digital badge management system data structure;
populating, by the processor, the automated digital badge management system data structure with the role data and the proficiency data;
determining, by the processor, a recommended digital badge to achieve and one or more recommended actions to perform to achieve the recommended digital badge based on the role data and the proficiency data in the automated digital badge management system data structure; and
providing, by the processor, the recommended digital badge to achieve and the one or more recommended actions to perform to achieve the digital badge to the automated digital badge management client device.

16. The computer program product of claim 15, further comprising:
displaying the recommended digital badge to achieve and the one or more recommended actions to perform to achieve the recommended digital badge at the automated digital badge management client device.

17. The computer program product of claim 15, further comprising:
receiving further proficiency data associated with the one or more recommended actions to perform to achieve the recommended digital badge;
updating the one or more recommended actions to perform based on the further proficiency data; and
providing the updated one or more recommended actions to perform to the automated digital badge management client device.

18. The computer program product of claim 15, further comprising:
updating the automated digital badge management system data structure to indicate that the recommended digital badge has been achieved.

19. The computer program product of claim 15, wherein the automated digital badge management system data structure indicates digital badges achieved and further recommended digital badges to achieve based on the role data and the proficiency data in the automated digital badge management system data structure.

20. The computer program product of claim 15, further comprising:
evaluating the role data and the proficiency data in the automated digital badge management system data structure to determine progress towards one or more digital badges not yet achieved.
